(19) United States
(12) Patent Application Publication
(10) Pub. No.: US 2005/0211823 A1
(43) Pub. Date: Sep. 29, 2005

(54) Helicopter

(75) Inventor: Santino Pancotti, Gallarate (IT)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: Agusta S.p.A., Samarate (IT)

(21) Appl. No.: 11/059,887

(22) Filed: Feb. 17, 2005

(30) Foreign Application Priority Data
Feb. 27, 2004 (IT) TO2004A 000118

(51) Int. Cl. B64C 15/02

(52) U.S. Cl. 244/12.3

(57) ABSTRACT

A helicopter having a fuselage; and two rear wings located on opposite sides of the fuselage and having winglets, each projecting transversely from a free end of the relative wing.

The present invention relates to a helicopter of the type comprising a fuselage; a main rotor fitted to the top of a central portion of the fuselage; a secondary tail rotor; and two rear wings extending from opposite sides of the tail portion of the fuselage.

### BACKGROUND OF THE INVENTION

Within the industry, improvements are continually being made, especially as regards aerodynamic efficiency and flight stability in various operating conditions. As is known, aerodynamic efficiency can be improved by increasing lift or reducing the aerodynamic resistance of all the helicopter surfaces; and particular care is normally taken to avoid a significant increase in weight without a corresponding increase in lift.

### SUMMARY OF THE INVENTION

It is an object of the present invention to provide a helicopter designed to meet the above requirements in a straightforward, low-cost manner.

According to the present invention, there is provided a helicopter comprising a fuselage, and two rear wings located on opposite sides of said fuselage; characterized in that each said wing has a winglet projecting transversely from a free end of the wing.

### BRIEF DESCRIPTION OF THE DRAWINGS

A preferred, non-limiting embodiment of the present invention will be described by way of example with reference to the accompanying drawings, in which:

FIG. 1 shows a view in perspective of a helicopter in accordance with the present invention;

FIG. 2 shows a top plan view of the tail portion of the FIG. 1 helicopter illustrating the dynamic performance of the helicopter when the flight direction coincides with the apparent incident wind direction;

FIG. 3 shows a top plan view of the tail portion of the FIG. 1 helicopter illustrating the dynamic performance of the helicopter when the flight direction does not coincide with the apparent incident wind direction;

FIGS. 4 and 5 show larger-scale views in perspective illustrating the aerodynamic performance of end portions of helicopter rear wings according to known technology and in accordance with the teachings of the present invention respectively.

### DETAILED DESCRIPTION OF THE INVENTION

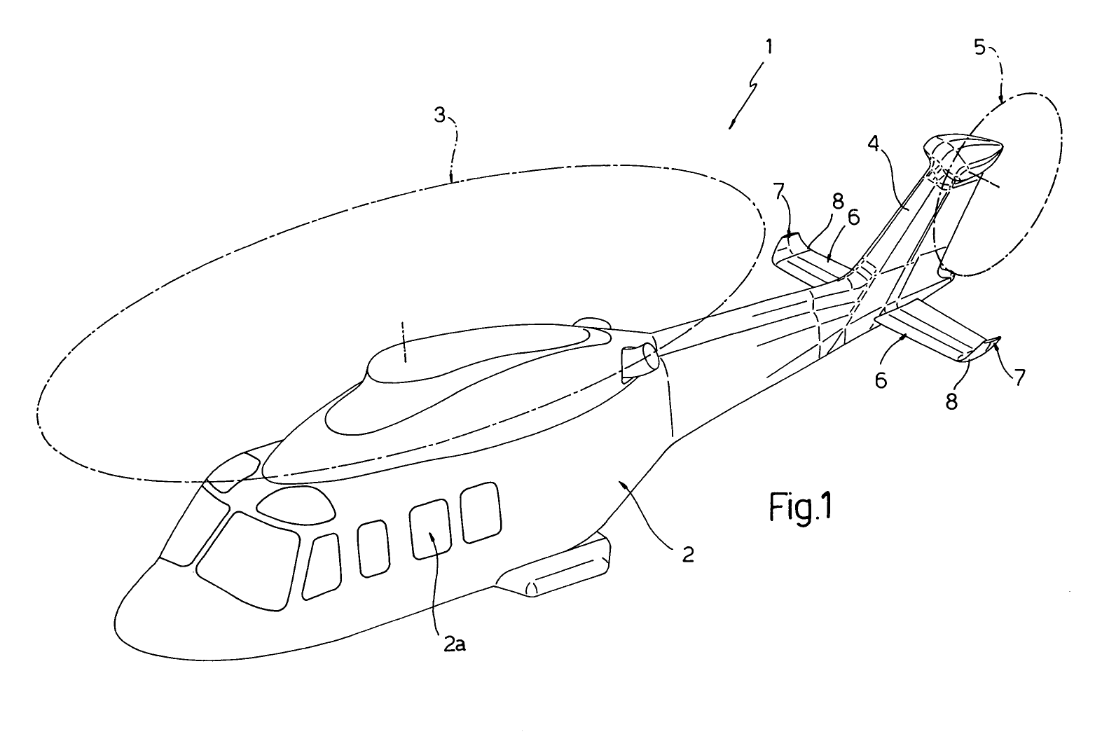

Number 1 in FIG. 1 indicates as a whole a helicopter comprising a fuselage 2 defining a front cockpit 2a; a main rotor 3 fitted to the top of fuselage 2; a rudder 4 projecting from the tail end of fuselage 2, and the top end portion of which is fitted with a secondary rotor 5; and two rear wings 6 projecting from opposite sides of fuselage 2, at and substantially perpendicular to rudder 4.

An important aspect of the present invention is that each rear wing 6 comprises a winglet 7 projecting transversely from a free end of wing 6.

More specifically, each winglet 7 comprises a flat underside 10 facing rudder 4; and an opposite convex topside 11. Each winglet 7 tapers in cross section towards its free end, and is connected to relative wing 6 by a curved portion 8.

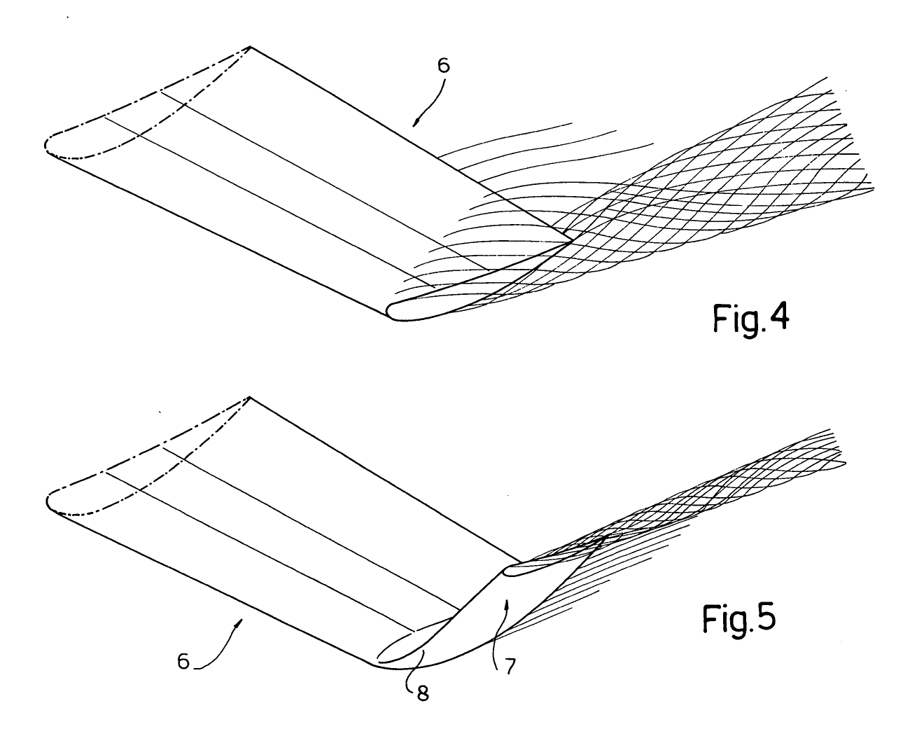

According to a known effect in aeronautics, winglets 7 provide for substantially reducing aerodynamic resistance produced by end vortices induced by the big pressure difference between underside and topside of wings 6. More specifically, FIGS. 4 and 5 show the airflow surface current lines on rear wings 6 without and with winglets 7 respectively. As can be seen from a comparison of FIGS. 4 and 5, in the case of rear wings 6 with winglets 7, the surface current lines adhere to the body of wing 6 to produce a more contained end vortex.

The aerodynamic action of winglets 7 and their location with respect to the barycentre G of helicopter 1, normally located at cockpit 2a, also provide for additional advantages in terms of improved lateral-directional stability of helicopter 1.

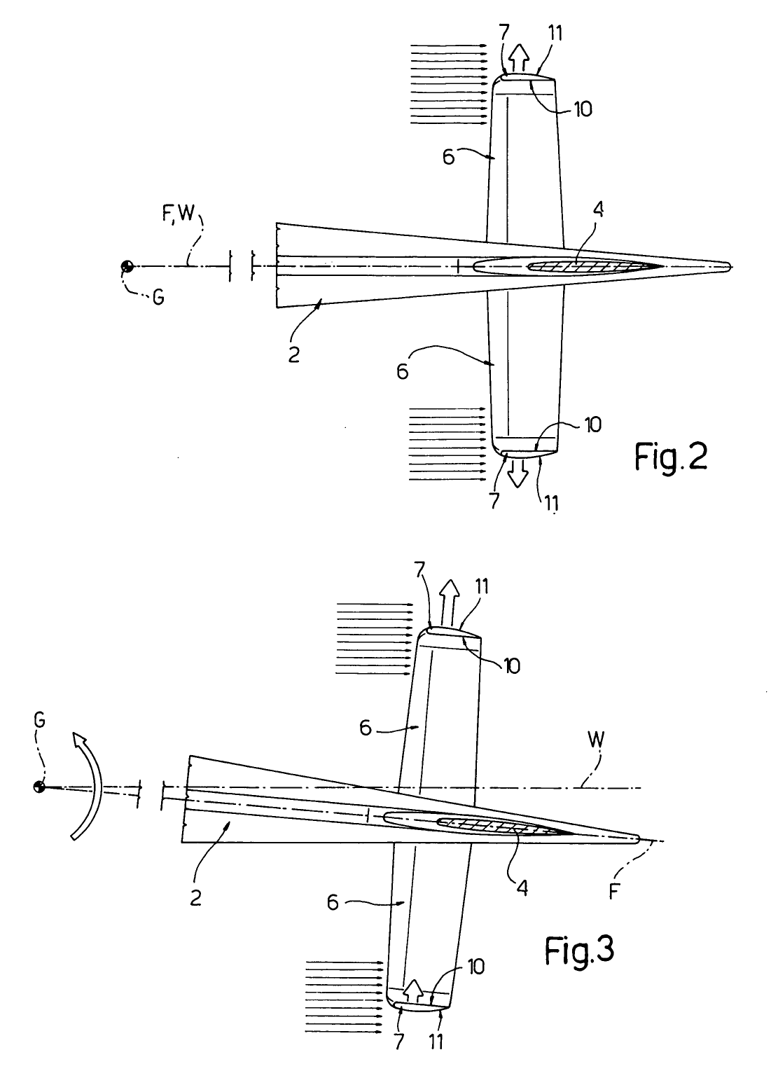

FIGS. 2 and 3 show the dynamic performance of helicopter 1—of which are shown schematically a tail portion with rear wings 6, and barycentre G—relative to two different flight operating conditions characterized by two parameters: flight direction F, and apparent incident wind direction W.

When flight direction F coincides with apparent incident wind direction W (FIG. 2), the aerodynamic action on winglets 7 gives rise to forces of like modulus and direction but opposite in sense, thus producing a zero resultant moment with respect to barycentre G of helicopter 1.

When flight direction F forms an angle with apparent incident wind direction W (FIG. 3), winglets 7 give rise to forces of different modulus and of like direction and sense, so that the resultant of the forces generated by winglets 7 with respect to barycentre G of helicopter 1 produces a stabilizing moment, i.e. which tends to restore helicopter 1 to apparent incident wind direction W.

Simply providing two winglets 7 projecting from the free ends of wings 6 therefore not only provides for substantially reducing aerodynamic resistance on wings 6, thus improving flight efficiency, but also for improving the lateral-directional stability of helicopter 1.

Clearly, changes may be made to helicopter 1 as described and illustrated herein without, however, departing from the scope of the accompanying Claims.

1) A helicopter (1) comprising a fuselage (2), and two rear wings (6) located on opposite sides of said fuselage (2); characterized in that each said wing (6) has a winglet (7) projecting transversely from a free end of the wing (6).

2) A helicopter as claimed in claim 1, characterized in that said winglets (7) extend perpendicularly from, and are connected to, the respective rear wings (6).

3) A helicopter as claimed in claim 1, characterized in that said winglets (7) extend upwards.
